(19) United States
(12) Patent Application Publication
(10) Pub. No.: US 2026/0296069 A1
(43) Pub. Date: Oct. 1, 2026

(54) LEARNING-BASED PRINTER PAPER POSITIONING METHOD, PRINTING METHOD FOR PRINTER PAPER, AND PRINTER

(71) Applicant: Shanghai Sunmi Technology Co., Ltd., Shanghai (CN)

(72) Inventors: Rixin YU, Shanghai (CN); Zhe LIN, Shanghai (CN)

(21) Appl. No.: 18/881,677

(22) PCT Filed: Apr. 28, 2023
(86) PCT No.: PCT/CN2023/091736

§ 371 Date: Jan. 6, 2025

(30) Foreign Application Priority Data
Jul. 6, 2022 (CN) 202210797887.6
Jul. 6, 2022 (CN) 202210798783.7

(51) Int. Cl. B41J 11/42; B41J 11/00; B41J 29/393

(52) U.S. Cl. CPC B41J 11/42; B41J 11/008; B41J 29/393

(57) ABSTRACT

The present application provides a learning-based printer paper positioning method, a printing method for printer paper, and a printer. The positioning method comprises the following steps: triggering a learning instruction, and searching for a plurality of adc value crests and a plurality of adc value troughs during the printing of printer paper; calculating a plurality of left edge crest-trough difference values of a plurality of measurement printing point positions corresponding to the plurality of adc value crests; determining a measurement positioning point according to the plurality of left edge crest-trough difference values, wherein the measurement positioning point corresponds to an adc value crest; and determining an adc reference value according to an adc value corresponding to the measurement positioning point, and then completing learning, so that printing units and connection areas in the printer paper are positioned during the printing of the printer paper according to the adc reference value. According to the learning-based printer paper positioning method and the printing method for printer paper of the present application, comprehensive learning can be performed on the positioning of printer paper, so that the printer can be compatible with more types of paper, the printing positioning accuracy is improved, and a storage space in the printer is optimized.

### TECHNICAL FIELD

The present application mainly relates to the field of printing positioning, and in particular to a learning-based printer paper positioning method, a printing method for printer paper, and a printer.

### BACKGROUND

There are many types of printer paper with label function on the market, and different printer paper has different characteristics of the analog-to-digital conversion value adc value fed back by the sensor. In order to be able to label different printer papers, it is necessary to conduct label learning before printing. At present, the paper positioning part in the commonly used printer usually has only one reflective sensor, and the prior art also proposes a single slope label learning method, but the compatibility breadth of printer paper is greatly limited. In addition, label positioning needs to store and judge a large amount of data on the adc value of the printer paper swept over, therefore, the existing mode of judging the printing positioning of the printer paper by the adc value occupies relatively large RAM space, which brings trouble to the configuration of the printer. Therefore, how to provide a printing solution with more versatility and less space occupation is an urgent problem to be solved in the field.

### SUMMARY

The characteristics and performance of the present application are further described by the following embodiments and drawings.

The technical problem to be solved in the present application is to provide a learning-based printer paper positioning method, a printing method of printer paper and a printer, the positioning of printer paper can be comprehensively studied, so that the printer is compatible with more types of paper and also improves the accuracy of printing positioning, optimizing the storage space inside the printer.

In order to solve the above-mentioned technical problems, the present application provides a learning-based printer paper positioning method, wherein the printer paper includes a plurality of printing units, each printing unit has a printing area and a connection area arranged in sequence, and the printer paper positioning method is suitable for positioning the printing area and the connection area during a printing process of the printer paper, characterized in that, the method comprises following steps: triggered by a learning instruction, searching for multiple adc value crests and multiple adc value troughs during the printing process of the printer paper; calculating multiple left edge crest-trough difference values of multiple measurement printing point positions corresponding to the multiple adc value crests according to the multiple adc value crests and the multiple adc value troughs, wherein the left edge crest-trough difference value is a difference between any one of adc value crests and an adc value trough adjacent to the any one of adc value crests; determining a measurement positioning point according to the multiple left edge crest-trough difference values, wherein the measurement positioning point corresponds to an adc value crest; completing learning after an adc reference value is determined by an adc value corresponding to the measurement positioning point, so that the printer paper positioning the printing unit and the connection area in the printer paper according to the adc reference value during the printing process.

In one embodiment of the present application, the step of searching for multiple adc value crests specifically comprises: continuously reading adc values in a printing direction of the printer paper, and if the adc values continue to increase, determining the printer paper in an adc value rising process until the adc values begin to decrease after any one of the measurement printing point positions, then determining the adc value crest is found, and searching for the adc value crests for multiple printing units respectively; and the step of searching for multiple adc value troughs specifically comprises: continuously reading adc values in the printing direction of the printer paper, and if the adc values continue to decrease, determining the printer paper in an adc value decreasing process until the adc values begin to increase after any one of the measurement printing point positions, then determining the adc value trough is found, and searching for the adc value troughs for multiple printing units respectively.

In one embodiment of the present application, it further comprises when the left edge crest-trough difference values corresponding to any measurement printing point positions satisfies a positioning condition, determining the measurement printing point position as the measurement positioning point.

In one embodiment of the present application, it further comprises extracting N consecutive ones among the multiple left edge crest-trough difference values, and calculating an average value of the N consecutive left edge crest-trough difference values as a difference average value, wherein the positioning condition includes a ratio of the left edge crest-trough difference value corresponding to any one of measurement printing point positions to the difference average value does not exceed a difference threshold, and a range of the difference threshold is 15~25.

In one embodiment of the present application, it further comprises the following steps: obtaining at least three measurement positioning points corresponding to at least three adjacent printing units corresponding along the printing direction during continuous printing process of the printer paper, wherein the three measurement positioning points include a first measurement positioning point, a second measurement positioning point, and a third measurement positioning point; and recording a distance between the measurement printing point positions corresponding to the first measurement positioning point and the second measurement positioning point as a first distance, recording a distance between the measurement printing point positions corresponding to the second measurement positioning point and the third measurement positioning point as a second distance, if a difference between the first distance and the second distance does not exceed a distance threshold, then determining positioning is successful, and recording an average value of the adc values corresponding to the first measurement positioning point, the second measurement positioning point and the third measurement positioning point as the adc reference value.

In one embodiment of the present application, it further comprises comparing at least three adc values corresponding to at least three measurement positioning points, and if the difference between the adc value corresponding to any measurement positioning point x and the adc value corresponding to any other measurement positioning point y exceeds an adc value difference threshold, discarding the measurement positioning point x and searching for another measurement positioning point again, wherein the adc value difference threshold is a ratio of the difference value to the adc value corresponding to the measurement positioning point y, and a range of the adc value difference threshold is 30-50%.

In one embodiment of the present application, the distance threshold includes a ratio of a difference between the second distance and the first distance to the first distance, and a range of the distance threshold is 5% to 15%.

In one embodiment of the present application, it further comprises: after determining the measurement printing point positions as the measurement positioning points, allowing the printer paper to continue printing a calibration distance to a calibration printing point, and during the continuing printing process, continuously calculating multiple left edge crest-trough difference values according to multiple adc value crests and multiple adc value troughs, if the left edge crest-trough difference values corresponding to any replacement printing point between the measurement printing point position and the calibration printing point is greater than the left edge crest-trough difference values corresponding to the measurement printing point positions, updating the measurement positioning point corresponding to the measurement printing point position to a replacement positioning point corresponding to the replacement printing point.

In one embodiment of the present application, the calibration distance is 5 mm~7.5 mm.

In one embodiment of the present application, if a length of the connection area in the printer paper exceeds a length threshold, the method further comprises: continuously reading the adc value in the printing direction of the printer paper, and calculating a slope from the measurement printing point position n to the measurement printing point position n-1 in real time, the slope from the measurement printing point position n-1 to the measurement printing point position n-2, and so on, and providing M slopes as a slope of the measurement printing point position n until finding multiple groups of slope starting points and slope ending points ; and determining whether any one of the measurement positioning points is located in a slope interval formed by any one of the multiple groups of slope starting points and slope ending points, then retaining the group of slope intervals if a determination result is yes.

In one embodiment of the present application, it further comprises calculating the length of the connection area in the printer paper according to the slope interval composed of at least two groups of slope starting points and slope ending points, so that jointly positioning the printer paper is realized according to the adc reference value and the length of the connection area during the printing process.

In one embodiment of the present application, the printer paper is printed by a printer during the printing process, the printer has a print head, a sensor, a stepper motor, a processor and a storage unit, the stepper motor drives the printer paper forward for printing, and the learning-based printer paper positioning method further comprises: during an initial state before triggered by the learning instruction, detecting through the sensor, starting the printing if the connection area is detected to be located in front of the print head and above or behind the sensor, otherwise, printing after re-determining position of the printer paper corresponding to the print head until returning to the initial state.

In one embodiment of the present application, it further comprises: during the initial state, if the connection area is located in front of the print head and located above or after the sensor, performing the following steps before starting printing: if the connection area locates in front of the print head and after the sensor, the stepper motor starting to print after advancing a first remaining step distance, wherein the first remaining step distance is a distance between the print head and the sensor minus a distance between an edge of the connection area and the sensor; if the connection area locates in front of the print head and above the sensor, the stepper motor starting to print after advancing a second remaining step distance, wherein the second remaining step distance is a distance between the print head and the sensor plus a length of the connection area and minus a distance that the sensor has advanced in the connection area.

In order to solve the above-mentioned technical problems, the present application provides a printer paper printing method, the printer paper formed by sequentially splicing multiple printing areas and multiple connection areas at intervals, the printer paper printed by a printer, wherein the printer has a print head, a sensor, a stepper motor, a processor and a storage unit, and the stepper motor drives the printer paper forward for printing, and the method comprises during an initial state of printing through the sensor, detecting through the sensor, starting the printing if the connection area is detected to be located in front of the print head and above or behind the sensor, otherwise, printing after re-determining position of the printer paper corresponding to the print head until returning to the initial state, wherein the step of re-determining the position of the printer paper corresponding to the print head includes: simultaneously executing a slope positioning algorithm and a crest-trough positioning algorithm to determine an adc reference value, so that the processor instructing the stepper motor to print the printer paper according to the adc reference value.

In one embodiment of the present application, it further comprises during the initial state of the printing, if the connection area locates in front of the print head and above or after the sensor, performing the following steps before starting printing: if the connection area locates in front of the print head and after the sensor, the stepper motor starting to print after advancing a first remaining step distance, wherein the first remaining step distance is a distance between the print head and the sensor minus a distance between an edge of the connection area and the sensor; if the connection area locates in front of the print head and above the sensor, the stepper motor starting to print after advancing a second remaining step distance, wherein the second remaining step distance is a distance between the print head and the sensor plus a length of the connection area, and minus a distance that the sensor has advanced in the connection area.

In one embodiment of the present application, the slope positioning algorithm includes continuously reading and recording adc values corresponding to a preset number of multiple printing positions, and continuously determining multiple slope intervals consisting of slope starting points and slope ending points in multiple cycles of the continuously increasing and decreasing adc values; the crest-trough positioning algorithm includes continuously reading the adc values corresponding to multiple printing positions, determining multiple adc value crests in multiple cycles of the continuously increasing and decreasing adc values, and determining a final positioning point according to the adc value crests, or determining the final positioning point according to the adc value crests and the multiple slope intervals together, thereby calculating the adc reference value according to the final positioning point.

In one embodiment of the present application, it further comprises obtaining a length of the connection area of the printer paper before the initial state of printing, and if the length of the connection area is greater than a length threshold, determining the final positioning point according to the adc value crests and the multiple slope intervals, wherein the length threshold is a constant between 3 mm~8 mm.

In one embodiment of the present application, the slope positioning algorithm further comprises: continuously reading the adc values corresponding to multiple printing positions during the printing process of the printer paper, and determining an adc value slope value corresponding to any two adjacent printing positions; determining N groups of slope starting points and slope ending points according to multiple adc value slope values; and caching the N groups of slope starting points and the slope ending points in the storage unit by the processor, wherein N is an integer greater than 0 and less than or equal to 10.

In one embodiment of the present application, the crest-trough positioning algorithm further comprises: continuously reading the adc values corresponding to multiple printing positions during the printing process of the printer paper, determining multiple adc value crests and multiple adc value troughs in multiple cycles of the continuously increasing and decreasing adc values; determining an alternative positioning point according to the multiple adc value crests and the multiple adc value troughs, wherein the alternative positioning point corresponds to any one of adc value crests; determining whether the alternative positioning point falls within any group of slope intervals consisting of the slope starting point and the slope ending point, if a determination result is no, directly determining the alternative positioning point as the final positioning point, otherwise, determining the final positioning point according to the slope starting point and the slope ending point where the alternative positioning point falls within; and calculating the adc reference value according to the adc value corresponding to the final positioning point and storing in the storage unit, so that the processor instructing the stepper motor to drive the printer paper forward for printing according to the adc reference value.

In one embodiment of the present application, the step of determining the alternative positioning point according to the multiple adc value crests and the multiple adc value troughs further comprises: calculating a difference value between multiple groups of adjacent adc value crests and adc value troughs; if a difference x between the adc value crest and the adc value trough in any group n1 exceeds a difference threshold z, then determining a printing position corresponding to the adc value crests of the group n1 as the alternative positioning point.

In one embodiment of the present application, it further comprises after determining the alternative positioning point, the stepper motor moving forward 80 to 120 steps from the printing position to the calibration printing point, and continuously reading multiple adc values, if a difference y between the adc value crest and the adc value trough in any group n2 obtained between the printing position and the calibration printing point exceeds the difference x, then updating the alternative positioning point to the printing position corresponding to the adc value crests of the group n2.

In one embodiment of the present application, the crest-trough positioning algorithm further comprises, determining a numerical value of the adc value crests A1 corresponding to the alternative positioning point and the adc reference value A0 stored in the storage unit; if a difference between A1and A0 exceeds 20%~60% of A0 and A1 is less than A0, discarding the alternative positioning point corresponding to A1, and searching for a new alternative positioning point.

In one embodiment of the present application, the crest-trough positioning algorithm further comprises determining multiple alternative positioning points, and calculating an average value d of distances between the printing positions corresponding to the multiple alternative positioning point, and if the difference between A1 and A0 exceeds 20%~60% of A0 and A1 is greater than A 0, determining a distance dx as the distance between the printing position corresponding to the alternative positioning point corresponding to A1 and the printing position corresponding to the alternative positioning point corresponding to A0, if a difference between the distance dx and the average value d is greater than 10% of the average value d, discarding the alternative positioning point corresponding to A1, and searching for a new alternative positioning point again.

In one embodiment of the present application, the step of calculating the adc reference value according to the adc value corresponding to the final positioning point further comprises: taking an average of the adc value crest A1 corresponding to the final positioning point and the adc reference value A0 stored in the storage unit as a new adc reference value and storing in the storage unit.

An embodiment of the present application also provides a printer, comprising a print head, a sensor, a stepper motor, a processor and a storage unit, wherein the processor is used to execute instructions to implement the method according to the above-mentioned method.

The other aspect of the application also provides a computer-readable medium storing computer program code, and the computer program code realizes the above-mentioned printing method when executed by a processor.

Compared with the prior art, this application has the following advantages: the learning-based printer paper positioning method and system of the present application utilize the change of adc value in the printer paper in the printing process, adopting the crest-trough positioning algorithm to accurately learn its positioning mode for the printer paper with the printing unit and the connection areas, so as to adapt to a variety of types of printer paper, making full use of the characteristics of the waveform without changing the number and characteristics of the sensor, and improving the compatibility breadth of the machine to the printer paper.

In the process of positioning the printer paper, this application records the position of the print head on the paper in real time, so that in the case of relatively large printing contents, the judgment of calculating positioning or repositioning can be carried out before starting the printing every time, and the printing content after positioning can cover all the printer paper, so as to avoid a large amount of paper waste.

This application can obtain the characteristic parameters for the printer paper being printed in each learning process of repositioning, and the distance and adc value can be verified in real time for the printing position corresponding to adc value crests during positioning, excluding the influence of the pre-printer content on the positioning result.

This application does not need to store a large number of adc values any more, and only needs to store the feature points required for calculation, which greatly optimizes the storage space and saves the cost under the premise of optimizing the printer positioning function.

### BRIEF DESCRIPTION OF THE DRAWINGS

The drawings are included to provide a further understanding of the present application, and they are included and constitute a part of the present application, the drawings show the embodiments of the present application, and serving to explain the principles of the present application together with the description. In the drawings:

FIG. 1 is a flow diagram of a learning-based printer paper positioning method in an embodiment of the present application;

FIG. 2 is a curve graph of the change of adc value in a learning-based printer paper positioning method in an embodiment of the present application; and

FIG. 3 is a system block diagram of a learning-based printer paper positioning system in an embodiment of the present application;

FIG. 4 is a flow diagram of the printer method of a printer paper in an embodiment of the present application;

FIG. 5 is a block diagram of a printer in an embodiment of the present application;

FIG. 6 is a schematic diagram of the position in the printing method of a printer paper in the embodiment of the present application;

FIG. 7 is a schematic diagram of the variation trend of adc value in a printing method of a sign paper in an embodiment of the present application; and

FIG. 8 is a flow diagram of the slope positioning algorithm and the crest-trough positioning algorithm in the printing method of a printer paper in an embodiment of the present application.

### PREFERRED EMBODIMENT OF THE PRESENT DISCLOSURE

In order to illustrate the technical solutions in the embodiments of the present application more clearly, the drawings that need to be used in the description of the embodiments will be briefly introduced below. Obviously, the drawings in the following description are only some embodiments of the present application, and for those skilled in the art, other drawings can also be obtained based on these drawings without creative effort. Unless otherwise specified from the context or otherwise, the same label represents the same structure or operation.

As indicated in this application and claims, the terms “a”, “an”, “a kind of” and/or “the” do not specifically refer to the singular and may include the plural unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The relative arrangements of components and steps, numerical expressions and numerical values set forth in these embodiments do not limit the scope of the present application unless specifically stated otherwise. At the same time, it should be understood that, for the convenience of description, the sizes of the various parts shown in the drawings are not drawn according to the actual proportional relationship. Techniques, methods and devices known to those of ordinary skill in the relevant art may not be discussed in detail, but where appropriate, such techniques, methods and devices should be considered part of the authorized specification. In all embodiments shown and discussed herein, any specific values should be construed as illustrative only, and not as limiting. Therefore, other examples of the exemplary embodiment may have different values. It should be noted that like numerals and letters denote like items in the following figures, therefore, once an item is defined in one figure, it does not require further discussion in subsequent drawings.

In the description of the present application, it should be understood that orientation words such as “front, back, up, down, left, right”, “landscape, portrait, vertical, horizontal” and “top, bottom” etc. indicating the orientation or positional relationship is generally based on the orientation or positional relationship shown in the drawings, only for the convenience of describing the application and simplifying the description, in the absence of a contrary statement, these orientation words do not indicate or imply that the device or element referred to must have a specific orientation or be constructed and operated in a specific orientation, and therefore cannot be construed as limiting the scope of protection of this application; the orientation words “inside and outside” refer to inside and outside relative to the outline of each part itself.

For the convenience of description, spatially relative terms may be used here, such as “on . . . ” , “over . . . ” , “on the upper surface of . . . ” , “above”, etc., to describe the spatial positional relationship between one device or feature and other devices or features. It will be understood that, in addition to the orientation depicted in the drawings, the spatially relative terms are intended to encompass different orientations of the device in use or operation. For example, if the device in the drawings is turned over, devices described as “on other devices or configurations” or “above other devices or configurations” would then be oriented “beneath other devices or configurations” or “under other devices or configurations” . Thus, the exemplary term “above” can encompass both an orientation of “above” and “beneath”. The device may be otherwise oriented (rotated 90 degrees or at other orientations), and making a corresponding explanation for the space relative description used here. In addition, it should be noted that the use of words such as “first” and “second” to define components is only for the convenience of distinguishing corresponding components, unless otherwise stated, the above words have no special meanings, and therefore cannot be construed as limiting the protection scope of the present application. In addition, although the terms used in this application are selected from well-known and commonly used terms, some terms mentioned in the specification of this application may be selected by the applicant according to his or her judgment, and their detailed meanings are listed in this article described in the relevant section of the description. Furthermore, it is required that this application be understood not only by the actual terms used, but also by the meaning implied by each term.

It will be understood that when an element is referred to as being “on,” “connected to,” “coupled to” or “in contacting with” another element, it can be directly on, connected to, coupled to, or in contact with the other element, or there may be an intervening component. In contrast, when an element is referred to as being “directly on,” “directly connected to,” “directly coupled to” or “directly in contacting with” another element, there are no intervening elements present. Likewise, when a first component is referred to as being “electrically contacting” or “electrically coupled to” a second component, there exists an electrical path between the first component and the second component that allows electrical current to flow. This electrical path may include capacitors, coupled inductors, and/or other components that allow current to flow, even without direct contact between conductive components.

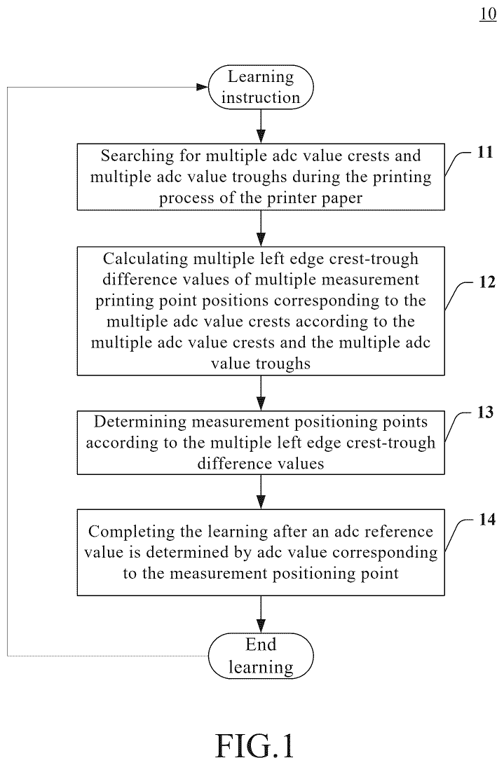

An embodiment of the present application provides a learning-based printer paper positioning method 10 (hereinafter referred to as “positioning method 10”) with reference to FIG. 1. Positioning method 10 can comprehensively learn the positioning of printer paper, so that the printer is compatible with more types of paper and improves the accuracy of printing positioning. The printer paper to which the positioning method 10 applies comprises a plurality of printing units, each printing unit has a sequentially arranged printing area and connection area. For example, the printer paper proposed in the present application can be understood as paper with a regular arrangement order, such as lottery paper, or printer paper containing commodity information with a pasting function, etc. The positioning method 10 is suitable for positioning the printing area and the connection area in the printing process of the printer paper, so that the printer can accurately print in the printing area.

The flow diagram is used in FIG. 1 of this application to illustrate the operations performed by the system according to the embodiment of this application. It should be understood that the preceding or following operations are not necessarily performed in an exact order. Instead, various steps may be processed in reverse order or concurrently. At the same time, other operations can either add to these procedures, or a certain step or steps can be removed from these procedures.

According to FIG. 1, the positioning method 10 comprises the following steps.

Step 11 is triggered by a learning instruction, searching for multiple adc value crests and multiple adc value troughs during the printing process of the printer paper. First of all, in practice, the learning instructions can come from the debugging process of the printing equipment or the formal printing process. Specifically, in the process of formal printing, whether it is in the initial state of the printer paper loading in machine or the time node of each pause in printing during each intermittent printing operation, learning instructions can be generated to position the printer paper ready for printing.

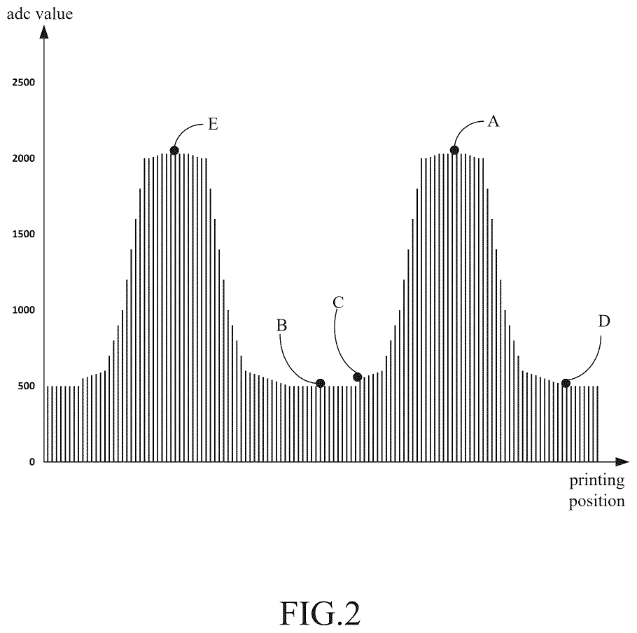

On the other hand, it should be noted that at the alternating place of the printing unit and the connection area, parameters such as the material and thickness of the paper will change. Using this physical property, when the reflective sensor illuminates the paper, a slowly rising or falling curve is obtained at the alternating place, as shown in FIG. 2, by obtaining the adc values at different print positions, the pattern of rising and falling of the adc value can be found. The rising and falling curves reflect the abrupt change when the reflective sensor is passing through a printing unit to the connection area or an abrupt change when the reflective sensor is passing through the connection area to the printing unit. Generally speaking, when the characteristic parameters of the printer paper are relatively stable, the waveform changes of each printing position will also be relatively stable during the printing process. In each cycle, a point A corresponding to the adc value crest value, a point B corresponding to the adc value trough, a slope starting point C of the slope of the adc value that begins to change, and a slope ending point D of the slope of the adc value that stops to change can be determined in each cycle. These features will be described in detail below.

For example, in a plurality of embodiments of the present application including FIG. 1, the step of searching for multiple adc value crests can specifically comprise continuously reading adc values in a printing direction of the printer paper, and if the adc values continue to increase, determining the printer paper in an adc value rising process until the adc values begin to decrease after any one of the measurement printing point positions, then determining the adc value crest is found, and searching for the adc value crests for multiple printing units respectively. Similarly, the step of searching for multiple adc value troughs specifically comprises continuously reading adc values in the printing direction of the printer paper, and if the adc values continue to decrease, determining the printer paper in an adc value decreasing process until the adc values begin to increase after any one of the measurement printing point positions, then determining the adc value trough is found, and searching for the adc value troughs for multiple printing units respectively.

Further, step 12 is calculating multiple left edge crest-trough difference values of measurement printing point positions corresponding to the multiple adc value crests according to multiple adc value crests and multiple adc value troughs obtained in step 11. Wherein the left edge crest-trough difference value is a difference between any one of adc value crests and an adc value trough adjacent to the any one of adc value crests. For example, for point A at crests, the left edge crest-trough difference value is the difference between the adc value corresponding to point A and the adc value corresponding to point B; the same operation will be applied to point E at crests. Thus, the left edge crest-trough difference value can be obtained for any one of crests.

Step 13 is determining the measurement positioning point according to the left edge crest-trough difference value. Wherein, every measurement positioning point corresponds to an adc value crest, which means in a waveform shown in FIG. 2, both point A and point E are likely to be measurement positioning points. Preferably, in some embodiments of the present application, it further comprises when the left edge crest-trough difference values corresponding to any measurement printing point position satisfies a positioning condition, determining the measurement printing point position (that is the feature point of the waveform) as the measurement positioning point, in this way, different filter conditions can be set according to the requirements of the actual application scenario. Exemplary, in some embodiments, the filter conditions can be set by the following ways. Extracting N consecutive ones among the multiple left edge crest-trough difference values, and calculating an average value of the N consecutive left edge crest-trough difference values as a difference average value, wherein the positioning condition includes a ratio of the left edge crest-trough difference value corresponding to any one of measurement printing point positions to the difference average value does not exceed a difference threshold, and a range of the difference threshold is 15~25. For example, when the difference threshold is 20, it means that if the left edge crest-trough difference value corresponding to the current measurement positioning point is greater than 20 times of the difference average value, then determining the current measurement positioning point as the maximum edge crest, which can be used as a candidate point for calculating the adc reference value. In this way, some small jitter of the adc value caused by the characteristic parameters of the paper can be eliminated.

Further preferably, in some embodiments of the present application, it further comprises after determining the measurement printing point positions as the measurement positioning points, allowing the printer paper to continue printing a calibration distance to a calibration printing point, and during the continuing printing process, continuously calculating multiple left edge crest-trough difference values according to multiple adc value crests and multiple adc value troughs, if the left edge crest-trough difference values corresponding to any replacement printing point between the measurement printing point position and the calibration printing point is greater than the left edge crest-trough difference values corresponding to the measurement printing point positions, updating the measurement positioning point corresponding to the measurement printing point position to a replacement positioning point corresponding to the replacement printing point. Exemplary, the calibration distance is 5 mm~7.5 mm.

In addition, the present application does not limit the number of measurement positioning point, and the number of measurement positioning point may be one or more. For example, in one embodiment of the present application, the number of measurement positioning point is 3. In such an embodiment, obtaining at least three measurement positioning points corresponding to at least three adjacent printing units corresponding along the printing direction during continuous printing process of the printer paper, wherein the three measurement positioning points include a first measurement positioning point, a second measurement positioning point, and a third measurement positioning point. After obtaining 3 measurement positioning points, recording a distance between the measurement printing point positions corresponding to the first measurement positioning point and the second measurement positioning point as a first distance, recording a distance between the measurement printing point positions corresponding to the second measurement positioning point and the third measurement positioning point as a second distance, if a difference between the first distance and the second distance does not exceed a distance threshold, then determining positioning is successful, and recording an average value of the adc values corresponding to the first measurement positioning point, the second measurement positioning point and the third measurement positioning point as the adc reference value. Exemplary, the distance threshold includes a ratio of a difference between the second distance and the first distance to the first distance, and a range of the distance threshold is 5% to 15%. For example, if the distance threshold is selected as 10%, the deviation of the second distance from the first distance needs to be no more than 10% to meet the positioning requirements. The condition of the above distance threshold is based on that the characteristics of the printing units and connection areas in the printer paper is in a fixed regular order, and if there is a large fluctuation or deviation between the distance from the previous measurement positioning point after determining the measurement positioning point, it is considered that the selection of the measurement positioning point is a failure, then abandon the measurement positioning point and reselect it to eliminate the change of the adc value in the printer paper due to other factors.

More preferably, in addition to comparing the distances, in some embodiments of the present application it further comprises comparing at least three adc values corresponding to at least three measurement positioning points, and if the difference between the adc value corresponding to any measurement positioning point x and the adc value corresponding to any other measurement positioning point y exceeds an adc value difference threshold, discarding the measurement positioning point x and searching for another measurement positioning point again, wherein the adc value difference threshold is a ratio of the difference value to the adc value corresponding to the measurement positioning point y, and a range of the adc value difference threshold is 30-50%. This means that the difference in adc values corresponding to three adjacent measurement positioning points needs to be paid attention to, and if the deviation is not large, for example, the deviation does not exceed 40%, it is considered that the change in the adc value is acceptable, then continue to conduct step 14 and further complete the learning.

Finally, step 14 is to determine the adc reference value according to the adc value corresponding to the measurement positioning point. For example, for an embodiment in which one measurement positioning point is selected, the adc reference value corresponds to the adc reference value corresponding to the measurement positioning point. For an embodiment in which multiple (such as three) measurement positioning points are selected, the adc reference value is the average value of the adc values corresponding to the multiple measurement positioning points. Completing learning after step 14, the adc value obtained through the above-mentioned learning process allows the printer paper to position the printing unit and the connection area in the printer paper according to the adc reference value in the printing process, until learning instruction is received again.

In the different embodiments of the present application, there are further variants on the basis of the positioning method 10 shown in FIG. 1. Some embodiments of this application also comprise paying attention to the slope interval in the adc value variation curve. In some embodiments, the length of the connection area in the printer paper exceeds a length threshold, such as 5 mm, and for this kinds of embodiments, the accuracy of learning can be further improved with the help of the slope parameter in the adc value variation curve. In such embodiments, the learning-based printer paper positioning method of the present application further comprises: continuously reading the adc value in the printing direction of the printer paper, and calculating a slope from the measurement printing point position n to the measurement printing point position n-1 in real time, the slope from the measurement printing point position n-1 to the measurement printing point position n-2, and so on providing M slopes as a slope of the measurement printing point position n until finding multiple groups of slope starting points and slope ending points, for example, point C and point D as shown in FIG. 2. For example, M can be an integer between 10~20. And on this basis, determining whether any one of the measurement positioning points is located in a slope interval formed by any one of the multiple groups of slope starting points and slope ending points, then retaining the group of slope intervals if a determination result is yes, and the positioning point used to calculate the adc reference value can be determined by taking the average value of the printing position corresponding to the slope starting point of the slope and the printing position corresponding to the ending point of the slope in the slope interval. Conversely, if the length of the connection area in the printer paper is always small, it is assumed that the measurement positioning points obtained by the above-mentioned crest-trough positioning algorithm are usually accurate, so that the suitable algorithm can be used for different paper types. Further, it can calculate the length of the connection area in the printer paper according to the slope interval composed of at least two groups of slope starting points and slope ending points, so that jointly positioning the printer paper according to the adc reference value and the length of the connection area during the printing process is realized.

Regardless of whether it is a basic embodiment or a preferred embodiment, the learning-based printer paper positioning system proposed in the present application finds the measurement positioning point and learns the parameters related to the printing positioning through rigorous analysis of the adc value variation curve, so that the printer is compatible with more types of paper and improves the accuracy of the printing positioning.

Further preferably, in some preferred embodiments of the present application, the printer paper printed by a printer during the printing process, the printer has a print head, a sensor, a stepper motor, a processor and a storage unit, the stepper motor drives the printer paper forward for printing, and the learning-based printer paper positioning method further comprises: during an initial state before triggered by the learning instruction, detecting through the sensor, starting the printing if the connection area is detected to be located in front of the print head and above or behind the sensor, otherwise, printing after re-determining position of the printer paper corresponding to the print head until returning to the initial state again.

Further, some of the printing methods further comprise during the initial state, if the connection area is located in front of the print head and located above or after the sensor, performing the following steps before starting printing: if the connection area locates in front of the print head and after the sensor, the stepper motor starts to print after advancing a first remaining step distance, wherein the first remaining step distance is a distance between the print head and the sensor minus a distance between an edge of the connection area and the sensor; if the connection area locates in front of the print head and above the sensor, the stepper motor starts to print after advancing a second remaining step distance, wherein the second remaining step distance is a distance between the print head and the sensor plus a length of the connection area and minus a distance that the sensor has advanced in the connection area. An example of applying the above learning-based printer paper positioning method is explained in further detail below.

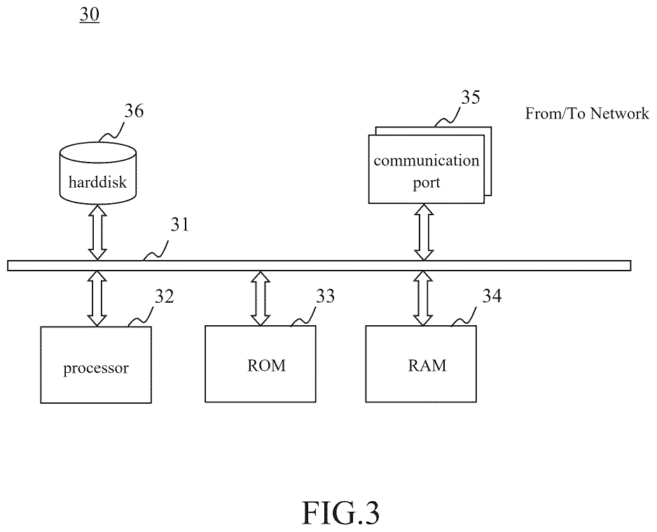

An embodiment of the present application also provides a learning-based printer paper positioning system 30 as shown in FIG. 3. According to FIG. 3, the learning-based printer paper positioning system 30 may comprise an internal communication bus 31, a processor 32, a read-only memory (ROM) 33, a random access memory (RAM) 34, and a communication port 35. When applied on a personal computer, a learning-based printer paper positioning system 30 may also include a hard disk 36.

The internal communication bus 31 can realize data communication between the components of the learning-based printer paper positioning system 30. The processor 32 can make judgments and give prompts. In some embodiments, the processor 32 may be composed of one or more processors. The communication port 35 can realize the data communication between the learning-based printer paper positioning system 30 and the outside. In some embodiments, the learning-based printer paper positioning system 30 can send and receive information and data from a network through a communication port 35.

The learning-based printer paper positioning system 30 may also comprise different forms of program storage units and data storage units, such as a hard disk 36, a read-only memory (ROM) 33 and a random access memory (RAM) 34, which is capable of storing various data files used by a computer for processing and/or communication, and possible program instructions executed by the processor 32. The processor executes these instructions to implement the main part of the method. The results of the processor processing are transmitted to the user device through the communication port and displayed on the user interface.

In addition, another aspect of the present disclosure also proposes a computer-readable medium storing computer program codes, the computer program codes implements the above-mentioned learning-based printer paper positioning method for when executed by a processor.

On the basis of the above-mentioned learning-based printer paper positioning method, the application also provides a preferred printer paper printing method, which combines the crest-trough positioning algorithm for calculating the adc reference value according to the adc crests and adc troughs described above and the slope positioning algorithm for co-localization of slope intervals, therefore, the theoretical positioning optimization method of printer paper is further extended to the printing optimization process of the printer in actual printing. This section will be illustrated below.

In the conventional art, the positioning of label printer paper can adopt the mode label positioning method, and the exemplary positioning process is as follows:
1. Collecting adc value for each step of the stepper motor;
2. Recording the number of occurrences of each adc value in the range of 0~4095, and recording the adc value with the most occurrences after walking 10 cm as the reference value for the next positioning
3. Since the length of the printing area is much longer than the length of the gap, so the adc with the most occurrences must also be the printing area, and the gain is added to this reference value to obtain the adc cut-off value; and
4. During the positioning process, if the collected adc value is greater than the adc cut-off value, it is considered to be a gap, and if the adc value is less than the adc cut-off value, it is considered to be printer paper.

Although this method can achieve the positioning effect of printer paper in most cases, it has the following drawbacks: the mode label positioning method needs to record the number of occurrences of each adc, for example, it needs to consume at least 8192Bytes in the interval of 0~4095, which is a huge overhead on the MCU where RAM resources are scarce. The adc cut-off value obtained by estimation is very close to the adc value of the printing area, which requires that the jitter of the printing area in the printing process shall not exceed the adc cut-off value, but it cannot guarantee that most printer papers have such a smooth adc curve, so it will lead to the frequent misjudgment of some printer papers with strong jitter. In addition, for pre-printer paper, the pre-printer content will cause an abrupt change in the adc value, which will exceed the adc cut-off, resulting in localization to the pre-printer content, thus making the positioning invalid. Finally, due to the print head and the sensor are not on the same horizontal line, after the positioning is completed, the print head is not in the positioning position, and there will be a section of the printer paper that cannot cover the printing, resulting in the low utilization rate of the whole roll of printer paper.

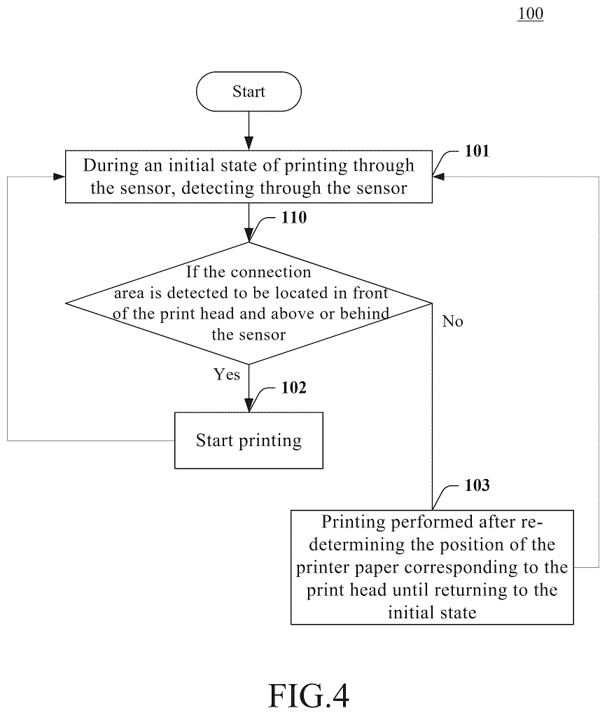

Based on these defects, an embodiment of the present application provides a printing method 100 of printer paper (hereinafter referred to as “printing method 100”) with reference to FIG. 4, which can realize the precise positioning of the printing of the printer paper, suitable for more kinds of printer paper, and optimizing the storage space inside the printer.

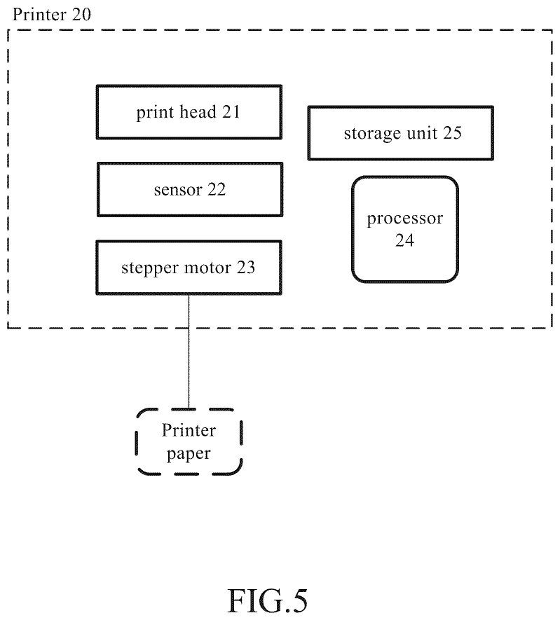

In order to illustrate the printing method 40 more clearly, a printer 20 proposed in an embodiment of the present application is first introduced according to FIG. 5. In a plurality of embodiments of the present application including FIG. 1, the printer paper suitable for the printing method is formed by sequentially splicing multiple printing areas and multiple connection areas at intervals, for example, the printer paper referred to in the plural embodiments of the present application is the printer paper of a supermarket weighing table that can print out information such as commodity items and weights. The printer paper can be composed of a printing area and a base plate in shape, and the printed printer paper can tear off part of the printing area and stick it to the product. In addition, there is a connection area between the printing areas, which makes it easy to tear the printing area intermittently. Such printer paper is printed by the printer 20 as shown in FIG. 5, the printer 20 has a print head 21, a sensor 22, a stepper motor 23, a processor 24 and a storage unit 25, and the stepper motor 23 drives the printer paper forward for printing through the print head 21. The sensor 22 illustratively obtains information about the paper being printed by reflection. The printer 20 shown in FIG. 5 can be applied to the printing method of printer paper in any embodiment proposed in the present application. The printing method of the printer paper proposed in the present application will be described below.

First of all, referring to FIG. 4, the printing method 100 comprises the following steps: the step 101 is detecting through the sensor during an initial state of printing, if the connection area is detected to be located in front of the print head and above or behind the sensor in step 101, then executing step 102 and starting printing, otherwise, executing step 103 and printing after re-determining position of the printer paper corresponding to the print head. According to FIG. 4, whether step 102 or step 103 is executed, the process finally leads to step 101, that is, whether it is after directly starting printing, or after re-determining the position of the printer paper corresponding to the print head and then printing, continuing to wait the initial state of the next printing, and the judgment step of step 110 will be executed again, so that the printing position is continuously corrected in the whole process of printing. It should be noted that the initial state of printing mentioned in this application can be understood as the time node when printing is about to start after each printing is suspended. For example, if a whole roll of paper has just been loaded into the machine, it is the initial state of printing; and in the printing process, sometimes it is a continuous printing of multiple printing areas or the intermittent printing of each paper, and the time node of each printing area to be printed next can be understood as the initial state of printing described in the present application.

Specifically, in the above embodiment, the step of re-determining the position of the printer paper corresponding to the print head includes: simultaneously executing a slope positioning algorithm and a crest-trough positioning algorithm to determine an adc reference value, so that the processor instructing the stepper motor to print the printer paper according to the adc reference value.

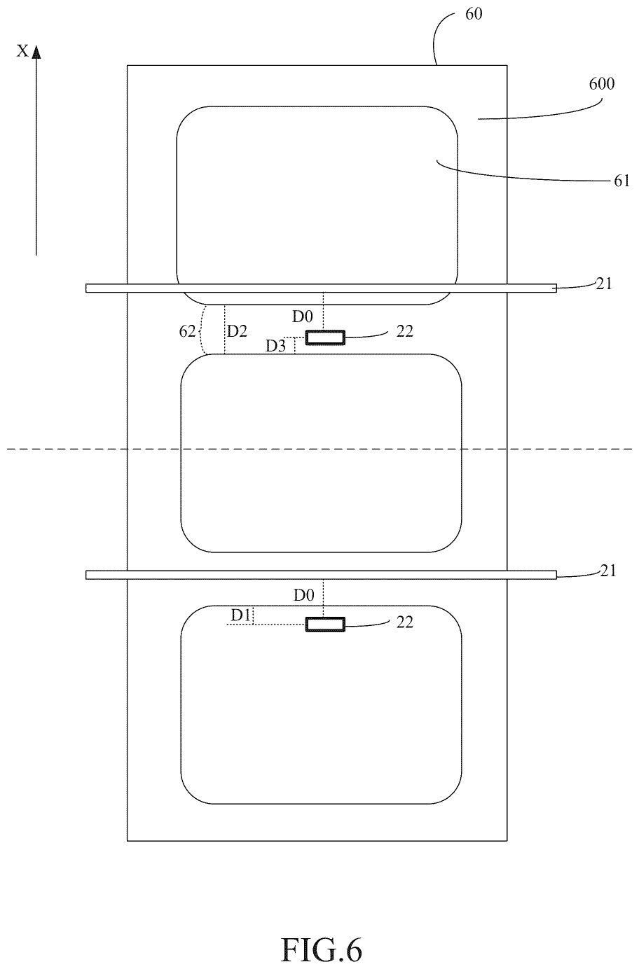

Preferably, some embodiments of the present application are further optimized and improved on the basis of the printing method 100 shown in FIG. 4, and these variants and preferred schemes are further described below. First, in some embodiments of the present application, according to the judgment step 110 of FIG. 4, if the connection area is detected to be located in front of the print head and above or behind the sensor during the initial state of the printing, performing the steps to calculate the printing positioning before officially starting printing in step 102. To illustrate more clearly how to calculate the printing positioning, FIG. 6 shows an example of a printer paper 60. According to FIG. 6, the printer paper 60 is composed of an intermittent printing area 61 and a base plate 600, a connection area 62 is provided between the adjacent printing areas 61, and the paper-walking direction of the printer paper 60 in the printing process is the X direction as shown in FIG. 6. In addition, the sensor 22 and the print head 21 in the printer 20 shown in FIG. 5 are also schematically shown in FIG. 6, and there is a fixed distance D0 between the sensor 22 and the print head 21.

In order to illustrate more clearly the position relationship of the component structure in different situations, two different position relationships are schematically shown in a piece of printer paper 60 in FIG. 6. The part below the dotted line is the case that should calculate the first step distance, and the part above the dotted line is the case that should calculate the second step distance. Specifically, paying attention to the part below the dotted line line first, if the connection area 62 locates in front of the print head 21 and after the sensor 22, the stepper motor 23 starts to print after advancing a first remaining step distance, wherein the first remaining step distance is a distance D0 between the print head 21 and the sensor 22 minus a distance D1 between an edge of the connection area 62 and the sensor 22. On the other hand, referring to the part above the dotted line, if the connection area 62 locates in front of the print head 21 and above the sensor 22 (i.e., sensor 22 is at the gap position between adjacent printing areas 61), the stepper motor 23 starts to print after advancing a second remaining step distance, wherein the second remaining step distance is a distance D0 plus a length D2 of the connection area, and minus a distance D3 that the sensor has advanced in the connection area.

According to FIG. 6, it can be seen that, whether it is the case of calculating the first remaining step distance or calculating the second remaining step distance, the position of the print head 21 can be fine-tuned at the time node that the printer 20 is about to print by the above-mentioned method, so that it can continue to print on the adjacent next printing area 61. Thus the position of the print head 21 is continuously corrected in the whole process of printing on the whole roll of printer paper, thereby improving the stability of the printing process and saving paper.

The above describes the cases when it is possible to start printing directly, and the following describes the situations when re-determining is required. In step 103 shown in FIG. 4, with regard to the step of re-determining the position of the printer paper corresponding to the print head, there are specific implementations in different embodiments of the present application. Exemplary, in a plurality of embodiments of the present application including FIG. 4, the step 103 can simultaneously execute the slope positioning algorithm and the crest-trough positioning algorithm to determine the adc reference value, so that the processor 24 shown in FIG. 5 can instruct the stepper motor 23 to drive the printer paper forward according to the adc reference value and then start printing. Specifically, the slope positioning algorithm includes continuously reading and recording adc values corresponding to a preset number of multiple printing positions, and continuously determining multiple slope intervals consisting of slope starting points and slope ending points in multiple cycles of the continuously increasing and decreasing adc values. While the crest-trough positioning algorithm includes continuously reading the adc values corresponding to multiple printing positions, determining multiple adc value crests in multiple cycles of the continuously increasing and decreasing adc values, and determining a final positioning point according to the adc value crests, or determining the final positioning point according to the adc value crests and the multiple slope intervals together, thereby calculating the adc reference value according to the final positioning point. This approach will be explained in more detail below.

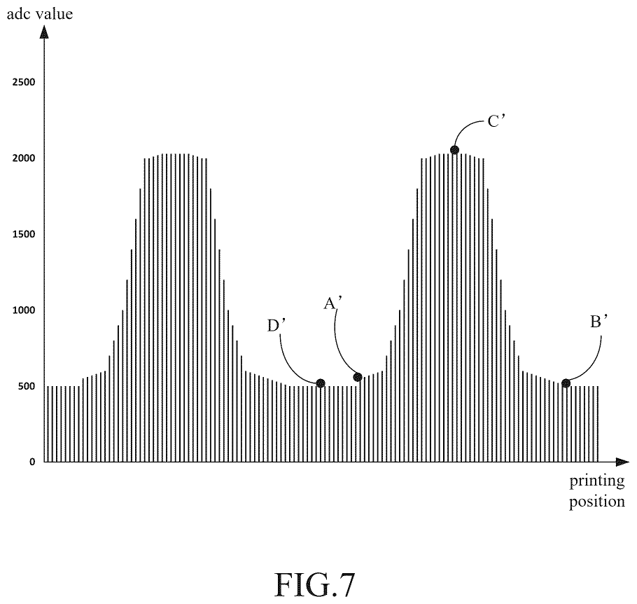

First of all, referring to FIG. 7, in the printing process of the printer paper, the adc values corresponding to different printing positions will also increase and decrease as the printing position moves forward. For example, as shown in reference FIG. 6, due to the parameter characteristics of the printing area 61 and the connection area 600 in the printer paper 60 are different, such as the material and the thickness are different, when the sensor 22 passes through the printing area 61 and the connection area 600, different adc values will be fed back through the sensor 22. Since the printing area 61 and the connection area 600 are arranged sequentially, from the feedback results of the adc value, the periodic rising, falling and gentle change curve can be presented as shown in FIG. 7, and the connection area 300 is usually the location with higher adc value, and the printing area 61 is usually the location with lower and gentle adc value. In the process of each upward and downward change, the C′ point corresponding to the adc value crest, the D′ point corresponding to the adc value trough, the A′ point where the ADC value begins to rise, and the B point where the ADC value ends falling can all be located. In the embodiments to be described later, point A′ and point B′ correspond to the slope starting point and slope ending point respectively, and point C′ is an alternative positioning point corresponding to the adc value crest (i.e., the measurement positioning point described in FIG. 1-3 in the preceding paragraphs).

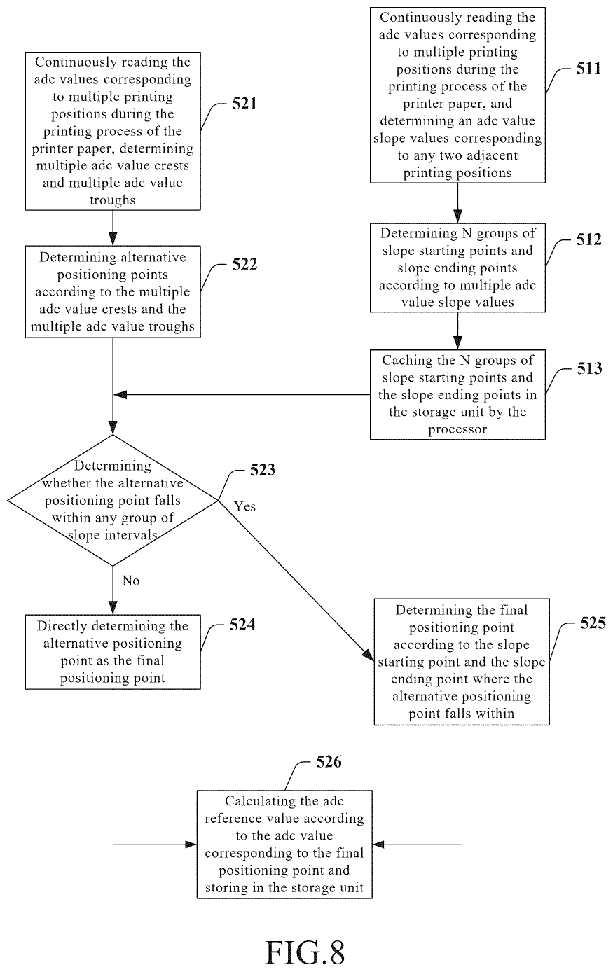

The flow diagram in FIG. 8 shows a more specific and preferred embodiment of the above-mentioned method for calculating the adc reference value in one embodiment of the present application. In the embodiment shown in FIG. 8, the slope positioning algorithm (specifically comprising steps 511~513) and the crest-trough positioning algorithm (specifically comprising steps 521~526) are carried out simultaneously in the printing process, and interacting and cooperating in a timely manner, which will be described in detail below.

Firstly, the slope positioning algorithm further comprises the following steps 511~513.

Step 511 is continuously reading the adc values corresponding to multiple printing positions during the printing process of the printer paper, and determining an adc value slope value corresponding to any two adjacent printing positions. As shown in FIG. 7, for two adjacent printing positions with sequential order, the adc value slope values can be obtained by comparing the latter adc value with the former adc value, and the adc value slope value is positive when the adc value continues to rise; and the adc value slope value is negative when the adc value continues to fall; and adc value slope value is 0 when the adc value area is flat. The adc value slope values can be used to obtain the trend of the adc value during the printing process. Step 512 is determining N groups of slope starting points and slope ending points according to multiple adc value slope values. For example, according to FIG. 4, the slope starting point A′ and the slope ending point B′ can be located in each cycle, and this step 512 is implemented to determine a certain number of slope starting points A′ and slope ending point B′ during the printing process, so as to determine the slope interval, such as the interval [A′, B′].

Finally, step 513 is caching the N groups of slope starting points and the slope ending points in the storage unit by the processor.

In the slope positioning algorithm, N is an integer greater than 0 and less than or equal to 10. But the present application is not limited to this, and in some other embodiments of the present application, according to the different configuration of the processing unit 25 or the different actual requirements, N can also be taken as an integer in the range greater than 10. For the common printers on the market, setting N to about 10 can satisfy the slope positioning algorithm without consuming too much space of the storage unit 25. Different from the mode of storing a large number of adc values in the prior art, due to the application does not only locate the connection area by calculating the changing slope of the adc value corresponding to the adjacent printing position, it is not necessary to store all the adc value data in the memory unit 25 of the printer 20.

On the other hand, in the embodiment shown in FIG. 8, the crest-trough positioning algorithm further comprises the following steps 521~526.

Step 521 is continuously reading the adc values corresponding to multiple printing positions during the printing process of the printer paper, determining multiple adc value crests and multiple adc value troughs in multiple cycles of the continuously increasing and decreasing adc values. As shown in FIG. 7, the maximum valuepoint of the adc value is point C′, and the adc trough is D′.

Step 522 is determining alternative positioning points according to the multiple adc value crests and the multiple adc value troughs, wherein the alternative positioning point (for example, point C′ as shown in FIG. 7) corresponds to any one of adc value crests.

Step 523 is determining whether the alternative positioning points fall within any group of slope intervals consisting of the slope starting point and the slope ending point, such as interval [A′, B′]. If a determination result is no, then executing step 524, which is directly determining the alternative positioning point as the final positioning point, otherwise executing step 525 determining the final positioning point according to the slope starting point and the slope ending point where the alternative positioning point falls within, for example, determining the final positioning point by taking average value of the printing positions corresponding to the slope starting point and the printing positions corresponding to the slope ending point.

Finally, executing step 526, calculating the adc reference value according to the adc value corresponding to the final positioning point and storing in the storage unit, so that the processor can instruct the stepper motor to drive the printer paper forward for printing according to the adc reference value.

On the basis of the embodiments shown in FIG. 5, this application has further optimization for the crest-trough positioning algorithm in some embodiments. First, for the step 522 determining an alternative positioning point according to the multiple adc value crests and the multiple adc value troughs, the following steps are further included in some preferred embodiments of the present application:
calculating a difference value between multiple groups of adjacent adc value crests and adc value troughs;
if a difference x between the adc value crest and the adc value trough in any group n1 exceeds a difference threshold z, then determining a printing position corresponding to the adc value crest of the group n1 as the alternative positioning point. Exemplary, in some embodiments of the present application, the difference threshold can be determined by the average value of multiple groups of differences, for example, choosing 18~25 times of the average value of the selected multiple groups of differences as the difference threshold. In this way, it is possible to filter out the fluctuations in the adc value due to paper and other factors, so as to accurately find the location of the connection area

Further, in such embodiments, it further comprises after determining the alternative positioning point, the stepper motor moving forward 80 to 120 steps from the printing position to the calibration printing point, and continuously reading multiple adc values; if a difference y between the adc value crest and the adc value trough in any group n2 obtained between the printing position and the calibration printing point exceeds the difference x, then updating the alternative positioning point to the printing position corresponding to the adc value crest of the group n2. In this way, the adc crest values can be further selected to improve the accuracy of the location of the printing position.

On the other hand, in some embodiments of the present application, the crest-trough positioning algorithm further comprises determining a numerical value of the adc value crest A1 corresponding to the alternative positioning point and the adc reference value A0 stored in the storage unit; if a difference between A1 and A0 exceeds 20%~60% (i.e. 40%) of A0 and A1 is less than A0, discarding the alternative positioning point corresponding to A1, and searching for a new alternative positioning point. In such an embodiment, the process of a single repositioning is not limited to the conclusion of the alternative positioning point found in the process, but is more globally compared with the adc reference value that has been stored in the memory unit, so that the accuracy of the printing positioning in the whole printing process can be improved.

In such embodiments, the crest-trough positioning algorithm further comprises determining multiple alternative positioning points, and calculating an average value d of distances between the printing positions corresponding to the multiple alternative positioning point, and if the difference between A1 and A0 exceeds 20%~60% (i.e. 40%) of A0 and A1 is greater than A0, determining a distance dx as the distance between the printing position corresponding to the alternative positioning point corresponding to A1 and the printing position corresponding to the alternative positioning point corresponding to A0; if a difference between the distance dx and the average value d is greater than 10% of the average value d, discarding the alternative positioning point corresponding to A1, and searching for a new alternative positioning point again. This means that only alternative positioning point that meets both the adc value condition and the printing location distance condition is accepted as trusted positioning point. In this way, the jitter of the paper during the printing process and the influence of the pre-printer content on the printing positioning can be further eliminated.

The calculation of the adc reference value is further explained. In some embodiments, the adc value corresponding to the selected alternative positioning point (or the optimized final positioning point) can be directly taken as the adc reference value, and in some preferred embodiments of the present application, the step of calculating the adc reference value based on the adc value corresponding to the final positioning point of step 526 shown in FIG. 8 further comprises taking an average of the adc value crest A1 corresponding to the final positioning point and the adc reference value A0 stored in the storage unit as a new adc reference value and storing in the storage unit. In this way, the influence of the decreasing radial thickness of the whole roll of printer paper on the printing positioning can be eliminated more effectively, so as to improve the accuracy of printing in the whole process of printing.

In the above embodiment of the present application, through the cooperation of crest-trough positioning algorithm and the slope positioning algorithm, the selection of alternative positioning points can be realized only according to the slope interval planned by the slope starting point and slope end point of a small number of feature points. But in some special embodiments of the present application, it further comprises obtaining a length of the connection area of the printer paper before the initial state of printing, and if the length of the connection area is greater than a length threshold, determining the final positioning point according to the adc value crests and the multiple slope intervals, wherein the length threshold is a constant between 3 mm~8 mm. Generally speaking, if the gap length is less than 5 mm, due to the short gap, it has been proved by a large number of experiments that a more reasonable and accurate adc reference value can be obtained through crest-trough positioning algorithm without excessive deviation. In the case of large gap length, the assistance of slope positioning algorithm is often needed to make the selection of alternative positioning points more accurate, improving the accuracy of positioning.

The existing algorithms (such as the mode label positioning method) have a single basis for judgment, which cannot improve the breadth of support for printer paper, and will lead to the decline of positioning accuracy due to the change of paper. The present method is used to achieve precise positioning of the printer paper and is compatible with many types of printer paper, even pre-printer paper. Meanwhile, the effect of optimizing the memory space of the present application is remarkable, for example, in some embodiments of the present application, compared with the space of about 8192 Bytes that need to be occupied in the prior art, the scheme of the present application only needs to occupy 239 Bytes of space by storing only feature points. Therefore, the printing method of the printer paper of the present application and the printer applied to it have very significant advantages regardless of the effect of precise printing positioning, the used type of printer paper, or the memory space

Another aspect of the present disclosure also proposes a computer-readable medium storing computer program codes, the computer program codes implements the above-mentioned method for measuring the battery impedance value when executed by a processor.

The basic concepts have been described above, obviously, for those skilled in the art, the above disclosure of the disclosure is only an example, and does not constitute a limitation to the present application. Although not expressly stated here, various modifications, improvements and amendments to this application may be made by those skilled in the art. Such modifications, improvements, and amendments are suggested in this application, so such modifications, improvements, and amendments still belong to the spirit and scope of the exemplary embodiments of this application.

Meanwhile, the present application uses specific words to describe the embodiments of the present application. For example, “one embodiment”, “an embodiment”, and/or “some embodiments” refer to a certain feature, structure or characteristic related to at least one embodiment of the present application. Therefore, it should be emphasized and noted that two or more references to “one embodiment” or “an embodiment” or “an alternative embodiment” in different places in this specification do not necessarily refer to the same embodiment. In addition, certain features, structures or characteristics of one or more embodiments of the present application may be properly combined.

Some aspects of the present application may be entirely implemented by hardware, may be entirely implemented by software (including firmware, resident software, microcode, etc.), or may be implemented by a combination of hardware and software. The above hardware or software may be referred to as “block”, “module”, “engine”, “unit”, “component” or “system”. The processor can be one or more Application Specific Integrated Circuits (ASIC), Digital Signal Processors (DSPs), Digital Signal Processing Devices (DAPDs), Programmable Logic Devices (PLDs), Field Programmable Gate Arrays (FPGAs), a processor, a controller, a microcontroller, a microprocessor, or a combination thereof. Additionally, aspects of the present application may be embodied as a computer product comprising computer readable program code on one or more computer readable media. For example, computer-readable media may include, but are not limited to, magnetic storage devices (e.g., hard disks, floppy disks, magnetic tape . . . ), optical disks (e.g., compact disk CDs, digital versatile disks DVD . . . ), smart cards, and flash memory devices (e.g., cards, sticks, key drives . . . ).

A computer readable medium may contain a propagated data signal embodying a computer program code, for example, in baseband or as part of a carrier wave. The propagated signal may take many forms, including electromagnetic, optical, etc., or a suitable combination. The computer readable medium can be any computer readable medium other than computer readable storage medium, which can communicate, propagate or transfer the program for use by being connected to an instruction execution system, apparatus or device. Program code on a computer readable medium may be transmitted over any suitable medium, including radio, electrical cables, fiber optic cables, radio frequency signals, or the like, or combinations of any of the foregoing.

In the same way, it should be noted that in order to simplify the expression disclosed in the present application and help the understanding of one or more embodiments of the disclosure, in the foregoing description of the embodiments of the present application, sometimes multiple features are combined into one embodiment, drawings or descriptions thereof. However, this method of disclosure does not imply that the subject matter of the application requires more features than are recited in the claims. Indeed, embodiment features are less than all features of a single foregoing disclosed embodiment.

In some embodiments, numbers describing the quantity of components and attributes are used, it should be understood that such numbers used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the specification and claims are approximations that can vary depending upon the desired characteristics of individual embodiments. In some embodiments, numerical parameters should take into account the specified significant digits and adopt the general digit reservation method. Although the numerical ranges and parameters used in some embodiments of the present application to confirm the breadth of the scope are approximate values, in specific embodiments, such numerical values are set as precisely as practicable.

Although the present application has been described with reference to the current specific embodiments, those of ordinary skill in the art should recognize that the above embodiments are only used to illustrate the present application, and various equivalent changes or substitutions can also be made without departing from the spirit of the present application, therefore, as long as the changes and modifications to the above-mentioned embodiments are within the spirit of the present application, they will all fall within the scope of the claims of the present application.

1-23. (canceled)

24. A learning-based printer paper positioning method, wherein the printer paper includes a plurality of printing units, each printing unit has a printing area and a connection area arranged in sequence, and the printer paper positioning method is suitable for positioning the printing area and the connection area during a printing process of the printer paper, wherein, the method comprises following steps:
triggered by a learning instruction, searching for multiple adc value crests and multiple adc value troughs during the printing process of the printer paper;
calculating multiple left edge crest-trough difference values of multiple measurement printing point positions corresponding to the multiple adc value crests according to the multiple adc value crests and the multiple adc value troughs, wherein the left edge crest-trough difference value is a difference between any one of adc value crests and an adc value trough adjacent to the any one of adc value crests;
determining a measurement positioning point according to the multiple left edge crest-trough difference values, wherein the measurement positioning point corresponds to an adc value crest;
completing learning after an adc reference value is determined by an adc value corresponding to the measurement positioning point, so that the printer paper positioning the printing unit and the connection area in the printer paper according to the adc reference value during the printing process.

25. The method according to claim 24, wherein, the step of searching for multiple adc value crests specifically comprises: continuously reading adc values in a printing direction of the printer paper, and if the adc values continue to increase, determining the printer paper in an adc value rising process until the adc values begin to decrease after any one of the measurement printing point positions, then determining the adc value crest is found, and searching for the adc value crests for multiple printing units respectively; and
the step of searching for multiple adc value troughs specifically comprises: continuously reading adc values in the printing direction of the printer paper, and if the adc values continue to decrease, determining the printer paper in an adc value decreasing process until the adc values begin to increase after any one of the measurement printing point positions, then determining the adc value trough is found, and searching for the adc value troughs for multiple printing units respectively.

26. The method according to claim 24, further comprising: when the left edge crest-trough difference values corresponding to any measurement printing point positions satisfies a positioning condition, determining the measurement printing point position as the measurement positioning point; extracting N consecutive ones among the multiple left edge crest-trough difference values, and calculating an average value of the N consecutive left edge crest-trough difference values as a difference average value, wherein the positioning condition includes a ratio of the left edge crest-trough difference value corresponding to any one of measurement printing point positions to the difference average value does not exceed a difference threshold, and a range of the difference threshold is 15~25.

27. The method according to claim 24, further comprising the following steps:
obtaining at least three measurement positioning points corresponding to at least three adjacent printing units corresponding along the printing direction during continuous printing process of the printer paper, wherein the three measurement positioning points include a first measurement positioning point, a second measurement positioning point, and a third measurement positioning point; and
recording a distance between the measurement printing point positions corresponding to the first measurement positioning point and the second measurement positioning point as a first distance, recording a distance between the measurement printing point positions corresponding to the second measurement positioning point and the third measurement positioning point as a second distance, if a difference between the first distance and the second distance does not exceed a distance threshold, then determining positioning is successful, and recording an average value of the adc values corresponding to the first measurement positioning point, the second measurement positioning point and the third measurement positioning point as the adc reference value.

28. The method according to claim 27, further comprising comparing at least three adc values corresponding to at least three measurement positioning points, and if the difference between the adc value corresponding to any measurement positioning point x and the adc value corresponding to any other measurement positioning point y exceeds an adc value difference threshold, discarding the measurement positioning point x and searching for another measurement positioning point again, wherein the adc value difference threshold is a ratio of the difference value to the adc value corresponding to the measurement positioning point y, and a range of the adc value difference threshold is 30-50%.

29. The method according to claim 24, further comprising: after determining the measurement printing point positions as the measurement positioning points, allowing the printer paper to continue printing a calibration distance to a calibration printing point, and during the continuing printing process, continuously calculating multiple left edge crest-trough difference values according to multiple adc value crests and multiple adc value troughs, if the left edge crest-trough difference values corresponding to any replacement printing point between the measurement printing point position and the calibration printing point is greater than the left edge crest-trough difference values corresponding to the measurement printing point positions, updating the measurement positioning point corresponding to the measurement printing point position to a replacement positioning point corresponding to the replacement printing point.

30. The method according to claim 24, wherein, if a length of the connection area in the printer paper exceeds a length threshold, the method further comprises:
continuously reading the adc value in the printing direction of the printer paper, and calculating a slope from the measurement printing point position n to the measurement printing point position n-1 in real time, the slope from the measurement printing point position n-1 to the measurement printing point position n-2, and so on, and providing M slopes as a slope of the measurement printing point position n until finding multiple groups of slope starting points and slope ending points ; and
determining whether any one of the measurement positioning points is located in a slope interval formed by any one of the multiple groups of slope starting points and slope ending points, then retaining the group of slope intervals if a determination result is yes.

31. The method according to claim 24, wherein, the printer paper is printed by a printer during the printing process, the printer has a print head, a sensor, a stepper motor, a processor and a storage unit, the stepper motor drives the printer paper forward for printing, and the learning-based printer paper positioning method further comprises:
during an initial state before triggered by the learning instruction, detecting through the sensor, starting the printing if the connection area is detected to be located in front of the print head and above or behind the sensor, otherwise, printing after re-determining position of the printer paper corresponding to the print head according to the learning-based printer paper positioning method until returning to the initial state;
during the initial state, if the connection area is located in front of the print head and located above or after the sensor, performing the following steps in front of starting printing:
if the connection area locates in front of the print head and after the sensor, the stepper motor starting to print after advancing a first remaining step distance, wherein the first remaining step distance is a distance between the print head and the sensor minus a distance between an edge of the connection area and the sensor;
if the connection area locates in front of the print head and above the sensor, the stepper motor starting to print after advancing a second remaining step distance, wherein the second remaining step distance is a distance between the print head and the sensor plus a length of the connection area and minus a distance that the sensor has advanced in the connection area.

32. A printer paper printing method, the printer paper formed by sequentially splicing multiple printing areas and multiple connection areas at intervals, the printer paper printed by a printer, wherein the printer has a print head, a sensor, a stepper motor, a processor and a storage unit, and the stepper motor drives the printer paper forward for printing, and the method is comprising:
during an initial state of printing through the sensor, detecting through the sensor, starting the printing if the connection area is detected to be located in front of the print head and above or behind the sensor, otherwise, printing after re-determining position of the printer paper corresponding to the print head until returning to the initial state,
wherein the step of re-determining the position of the printer paper corresponding to the print head includes: simultaneously executing a slope positioning algorithm and a crest-trough positioning algorithm to determine an adc reference value, so that the processor instructing the stepper motor to print the printer paper according to the adc reference value.

33. The method according to claim 32, further comprising during the initial state of the printing, if the connection area locates in front of the print head and above or after the sensor, performing the following steps before starting printing:
if the connection area locates in front of the print head and after the sensor, the stepper motor starting to print after advancing a first remaining step distance, wherein the first remaining step distance is a distance between the print head and the sensor minus a distance between an edge of the connection area and the sensor;
if the connection area locates in front of the print head and above the sensor, the stepper motor starting to print after advancing a second remaining step distance, wherein the second remaining step distance is a distance between the print head and the sensor plus a length of the connection area, and minus a distance that the sensor has advanced in the connection area.

34. The method according to claim 32, wherein, the slope positioning algorithm includes continuously reading and recording adc values corresponding to a preset number of multiple printing positions, and continuously determining multiple slope intervals consisting of slope starting points and slope ending points in multiple cycles of the continuously increasing and decreasing adc values;
the crest-trough positioning algorithm includes continuously reading the adc values corresponding to multiple printing positions, determining multiple adc value crests in multiple cycles of the continuously increasing and decreasing adc values, and determining a final positioning point according to the adc value crests, or determining the final positioning point according to the adc value crests and the multiple slope intervals together, thereby calculating the adc reference value according to the final positioning point.

35. The method according to claim 34, wherein, the slope positioning algorithm further comprises:
continuously reading the adc values corresponding to multiple printing positions during the printing process of the printer paper, and determining an adc value slope value corresponding to any two adjacent printing positions;
determining N groups of slope starting points and slope ending points according to multiple adc value slope values; and
caching the N groups of slope starting points and the slope ending points in the storage unit by the processor, wherein N is an integer greater than 0 and less than or equal to 10.

36. The method according to claim 34, wherein, the crest-trough positioning algorithm further comprises:
continuously reading the adc values corresponding to multiple printing positions during the printing process of the printer paper, determining multiple adc value crests and multiple adc value troughs in multiple cycles of the continuously increasing and decreasing adc values;
determining an alternative positioning point according to the multiple adc value crests and the multiple adc value troughs, wherein the alternative positioning point corresponds to any one of adc value crests;
determining whether the alternative positioning point falls within any group of slope intervals consisting of the slope starting point and the slope ending point, if a determination result is no, directly determining the alternative positioning point as the final positioning point, otherwise, determining the final positioning point according to the slope starting point and the slope ending point where the alternative positioning point falls within; and
calculating the adc reference value according to the adc value corresponding to the final positioning point and storing in the storage unit, so that the processor instructing the stepper motor to drive the printer paper forward for printing according to the adc reference value.

37. The method according to claim 36, wherein, the step of determining the alternative positioning point according to the multiple adc value crests and the multiple adc value troughs further comprises:
calculating a difference value between multiple groups of adjacent adc value crests and adc value troughs;
if a difference x between the adc value crest and the adc value trough in any group n1 exceeds a difference threshold z, then determining a printing position corresponding to the adc value crests of the group n1 as the alternative positioning point.

38. The method according to claim 37, further comprising after determining the alternative positioning point, the stepper motor moving forward 80 to 120 steps from the printing position to the calibration printing point, and continuously reading multiple adc values, if a difference y between the adc value crest and the adc value trough in any group n2 obtained between the printing position and the calibration printing point exceeds the difference x, then updating the alternative positioning point to the printing position corresponding to the adc value crests of the group n2.

39. The method according to claim 37, wherein, the crest-trough positioning algorithm further comprises, determining a numerical value of the adc value crests A1 corresponding to the alternative positioning point and the adc reference value A0 stored in the storage unit; if a difference between A1 and A0 exceeds 20%~60% of A0 and A1 is less than A0, discarding the alternative positioning point corresponding to A1, and searching for a new alternative positioning point.

40. The method according to claim 39, wherein, the crest-trough positioning algorithm further comprises determining multiple alternative positioning points, and calculating an average value d of distances between the printing positions corresponding to the multiple alternative positioning point, and if the difference between A1 and A0 exceeds 20%~60% of A0 and A1 is greater than A0, determining a distance dx as the distance between the printing position corresponding to the alternative positioning point corresponding to A1 and the printing position corresponding to the alternative positioning point corresponding to A0, if a difference between the distance dx and the average value d is greater than 10% of the average value d, discarding the alternative positioning point corresponding to A1, and searching for a new alternative positioning point again.

41. The method according to claim 39, wherein, the step of calculating the adc reference value according to the adc value corresponding to the final positioning point further comprises: taking an average of the adc value crest A1 corresponding to the final positioning point and the adc reference value A0 stored in the storage unit as a new adc reference value and storing in the storage unit.

42. A printer, comprising: a print head, a sensor, a stepper motor, a processor and a storage unit, wherein the processor is used to execute instructions to implement the method according to claim 24.

43. A printer, comprising: a print head, a sensor, a stepper motor, a processor and a storage unit, wherein the processor is used to execute instructions to implement the method according to claim 32.
